(19) United States
(12) Patent Application Publication
(10) Pub. No.: US 2013/0019769 A1
(43) Pub. Date: Jan. 24, 2013

(54) Screen printing ink pump with filter

(71) Applicants: Charles L. Williams, Omaha, NE (US); Sebastian A. Jung, Omaha, NE (US)

(72) Inventors: Charles L. Williams, Omaha, NE (US); Sebastian A. Jung, Omaha, NE (US)

(21) Appl. No.: 13/136,078

(22) Filed: Jul. 22, 2011

(51) Int. Cl. B41K 1/38; E03B 7/07

(52) U.S. Cl. 101/335; 137/544

(57) ABSTRACT

A screen printing ink pump which is designed to pump printing ink from a first container to a second container. A filter is provided at the discharge side of the pump above the second container to filter impurities from the ink during the pumping operation.

### BACKGROUND OF THE INVENTION

1. Field of the Invention

This invention relates to a screen printing ink pump and more particularly to a screen printing ink pump having a filter or screen associated therewith to filter out impurities such as clumps of carbon or coloring that have not been evenly distributed in suspension, carbon (coloring agent) elements that are too large to flow during the printing process, packaging particles which have become mixed with the ink, or any foreign object or element that has polluted the ink.

2. Description of the Related Art

In a screen printing process, the object to be printed is normally placed on a supporting surface and a screen having a stencil incorporated therewith which has the desired printing pattern thereon is placed on the object. Screen printing ink is then placed on the screen with the ink then being forced downwardly through the mesh openings in the stencil by way of a squeegee or the like. If the ink has clumps of carbon or coloring agent elements that have not been evenly distributed in suspension, packaging particle which have become mixed with the ink, or any foreign object or element that has polluted the ink, the ink will not be uniformly forced through the stencil, thereby resulting in an imperfect printing job. In the past, in an effort to remove the impurities from the ink, the ink was manually strained through a mesh-like strainer member such as a porous cheese cloth, chamois or other straining device. In normal practice, the strainer is placed over an empty container and the printing ink is poured from a first container through the strainer member into another container. The prior practice is extremely laborious, time consuming and messy.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A screen printing ink pump is disclosed wherein printing ink is pumped from one container to another container and is filtered of impurities during the pumping process. The system of this invention includes an elongated, generally vertically disposed ink dip tube having open upper and lower ends and an inner wall surface. The ink dip tube is adapted to be extended downwardly into the ink in the first container. The dip tube has a first valve seat provided thereon below its lower end which has a lower ink intake side and an upper ink discharge side. A first valve is positioned in the dip tube which is movably positioned at the upper ink discharge side of the first valve seat. The first valve is movable between a first position wherein the first valve closes the upper ink discharge side of the first valve seat to a second position wherein the first valve is unseated from the first valve seat to permit the ink in the first container to be drawn upwardly into the dip tube. A compression spring is positioned in the dip tube and which has upper and lower ends. The system also includes an elongated hollow piston rod having upper and lower ends. The piston rod is slidably extended downwardly into the upper end of the dip tube. The piston rod is movable between an upper extended position and a lower retracted position with respect to the dip tube. The piston rod has a hollow piston fixedly secured thereto adjacent the lower end thereof which slidably sealably engages the inner wall surface of the dip tube as the piston rod is moved between its first and second positions. The compression spring yieldably urges the piston rod towards its upper extended position.

A second valve seat is provided in the piston rod adjacent the upper end thereof. The second valve seat has a lower ink intake side and an upper ink discharge side. A second valve is movably positioned at the upper ink discharge side of the second valve seat. The second valve is movable between open and closed positions.

A push handle is secured to the upper end of the hollow piston rod with the push handle having an ink passageway formed therein which has an ink inlet end and an ink discharge end. The ink inlet end of the ink passageway in the push handle is in fluid communication with the upper ink discharge side of the second valve seat. The second valve, when in its open position, permits ink to flow from the upper end of the piston rod to the ink inlet end of the ink passageway in the push handle when the piston rod is moved from its extended position to its retracted position. The second valve is moved to its closed position when the piston rod is moved from its retracted position to its extended position.

A generally vertically disposed filter housing, having an upper ink intake end and a lower ink discharge end is also provided. The upper ink end of the filter housing is in fluid communication with the ink discharge end of the ink passageway and the push handle. An ink filter is positioned in the filter housing at the lower ink discharge end thereof. The filter housing is disposed laterally of the push handle, the piston rod and the dip tube so that the filter housing may be positioned over the second container. The ink discharge end of the filter housing is disposed in a plane which is higher than the lower end of the dip tube.

Although the apparatus of this invention is ideally suited for filtering ink for use in a screen printing operation, the apparatus could also be used in other situations wherein it is desired to remove impurities from liquids.

It is therefore a principal object of the invention to provide a screen printing ink pump having a filter associated therewith to filter out contaminants, globules, lumps, etc. from the printing ink.

A further object of the invention is to provide a screen printing ink pump with a filter associated therewith which is easy to use and which is not messy.

A further object of the invention is to provide a screen printing ink pump having a filter associated therewith which is easily cleaned and/or serviced.

A further object of the invention is to provide a screen printing ink pump having a filter associated therewith with the filter being removable therefrom so as to clean or replace the same.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a side elevational view of the apparatus of this invention being used to pump and filter printing ink with a portion of the containers being cut-away to more fully illustrate this invention;

FIG. 2 is an exploded perspective view of the apparatus of this invention; and

FIG. 3 is a partial vertical sectional view of the apparatus of this invention.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The screen printing ink pump with filter apparatus is generally designated by the reference numeral 10. The pump and filter of this invention is designed to draw printing ink 12 from a first container 14, filter the same and deposit the filtered ink into a second container 16.

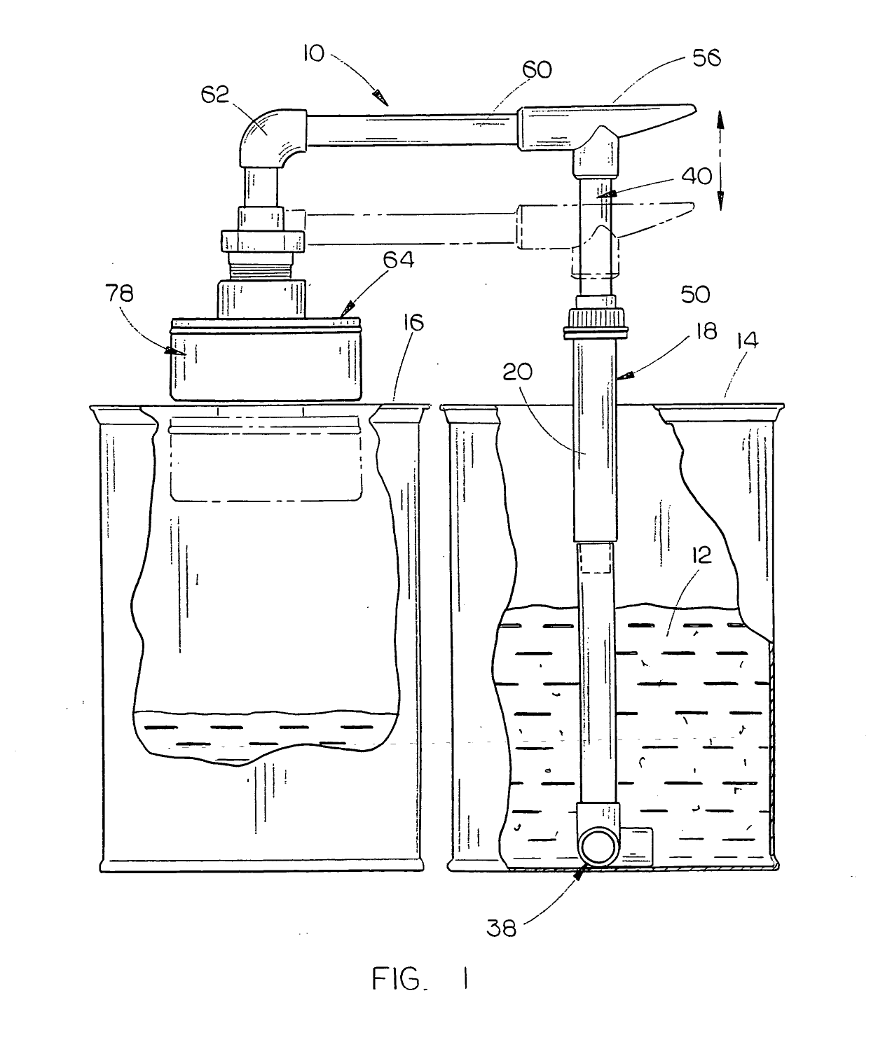

Apparatus 10 includes a conventional liquid or condiment pump 18 which includes a vertically disposed hollow dip tube 20 having external threads 22 at its upper end 24, a reduced diameter portion 26 at its lower end 28 which defines an outer shoulder 30 and inner shoulders 31 and 32. Dip tube 20 also has a conventional flap valve 34 provided in the interior thereof which is designed to seed upon inner shoulder or valve seat 31. Flap valve 34 is movable between open and closed positions. When flap valve 34 is closed, it prevents ink flow from the interior of dip tube 20 downwardly and outwardly through the lower end 28 of dip tube 20. When flap valve 34 is open, it permits ink flow upwardly through the lower end 28 of dip tube 20 into the interior of dip tube 20. If necessary, a hollow dip tube extender 36 may be secured to the lower end of dip tube 20. Preferably, the lower end of dip tube 36 has a hollow double elbow 38 secured thereto and designed to rest upon the bottom of the first container 14 as seen in FIG. 1.

Pump 18 also includes a hollow piston rod or plunger 40 having an upper end 42 and a lower end 44. Piston rod 40 has a flexible annular piston 46 at its lower end 44 which extends outwardly therefrom. Piston rod 40 has an external shoulder 48 formed therein below its upper end. An internally threaded cap 50 is mounted on piston rod 40 which is adapted to be threadably secured to the external threads 22 on the upper end of dip tube 20. The shoulder 48 limits the upward movement of piston rod 40 with respect to cap 50 when cap 50 is threaded onto the upper end of dip tube 20.

The numeral 54 refers to an elongated compression spring having an upper end 56 and a lower end 58. Spring 54 is positioned in dip tube 20 so that its lower end 54 engages inner shoulder 32 in dip tube 20. The upper end 56 of spring 54 engages the lower end of piston rod 40 to yieldably resist the downward movement of piston rod 40 with respect to dip tube 20 and yieldably urges piston rod 40 to its upper extended position.

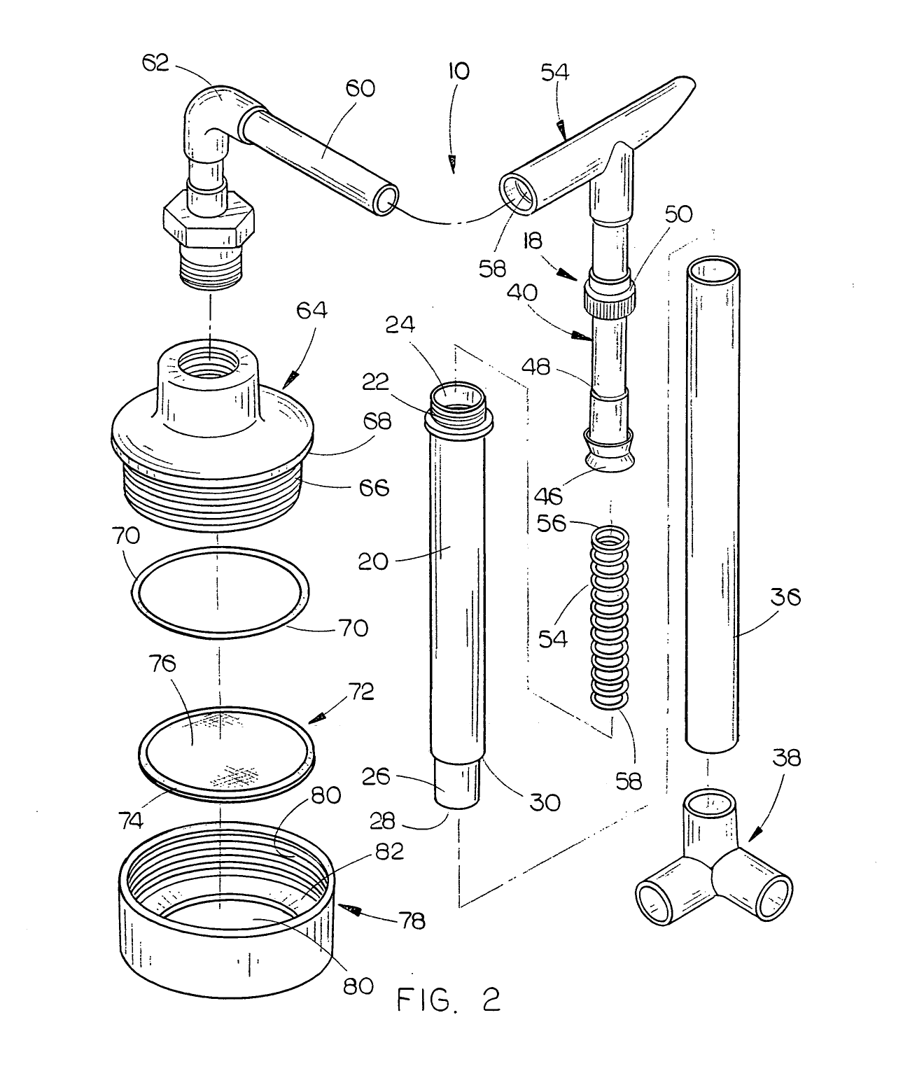

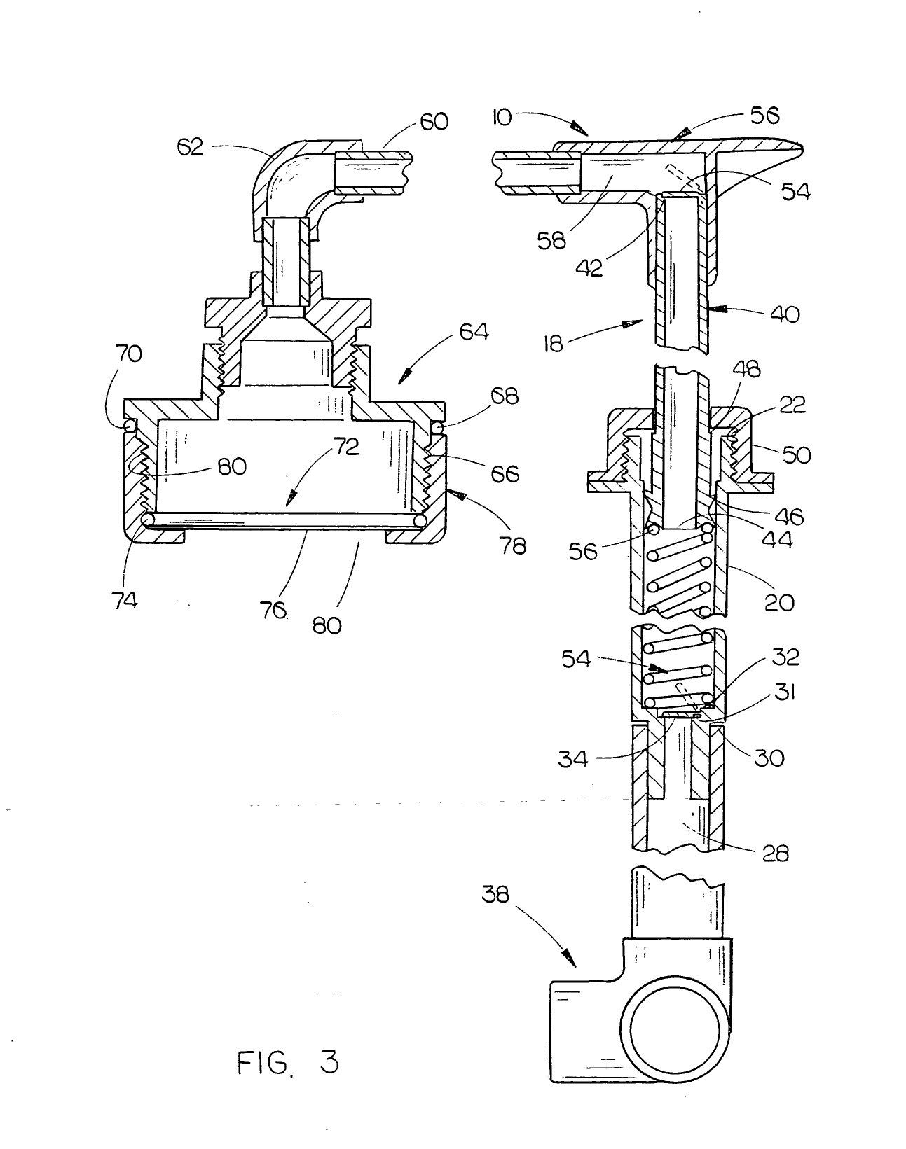

A flap valve 54 is mounted on the upper end of dip tube 40 and is movable between closed and open positions. The numeral 56 refers to a push handle having a passageway 58 extending therethrough. The intake end of passageway 58 is in fluid communication with the upper end of dip tube 40 by way of the flap valve 54. The discharge end of passageway 58 has the inlet end of a discharge tube 60 secured thereto as seen in FIG. 3. The discharge end of tube 60 has an elbow 62 secured thereto as seen in FIGS. 1-3. The discharge end of elbow 62 is operatively secured to a generally vertically disposed hollow filter housing 64 which has external threads 66 formed therein which defines an upper shoulder 68. O-ring 70 embraces the lower end of filter housing 64 so as to be positioned upwardly against the underside of shoulder 68.

The numeral 72 refers to the ink filter or screen of this invention. Filter 72 includes an O-ring 74 having a flexible screen or filter material 76 secured thereto and extending therebetween. The numeral 78 refers to a hollow cap having interior threads 80 and a discharge opening 80 defined by a shoulder 82. Filter 72 is positioned within cap 78 so that O-ring 74 seats upon shoulder 82. Cap 78 is threadably secured to the threads 66 of housing 64. The mesh size of the openings in the ink filter or screen 72 will depend upon the viscosity of the ink being filtered.

Although it is preferred that the apparatus of this invention utilizes a manually operated pump, the pump could be electrically driven.

The apparatus of this invention is used as follows. The container 14 which has the ink 12 to be filtered or screen is opened. The empty container 16 is positioned adjacent container 14 as illustrated in FIG. 1. The pump 18 is inserted downwardly into the container 14 until the double elbow 38 rests upon the bottom of the container 14 as seen in FIG. 1. At that time, the filter housing 64 is positioned over the upper open end of the container 16 as also seen in FIG. 1. At that time, the piston rod 40 will be in its extended position as illustrated by solid lines in FIG. 1. Initially, valve 34 may or may not be open and valve 54 may or may not be open. The push handle is then pushed downward so that piston rod 40 is slidably extended downwardly in dip tube 20 to its fully retracted or depressed position. The piston 46 sealably and slidably engages the interior wall surface of dip tube 20 as piston rod 40 is moved downwardly to expel any air within dip tube 20 upwardly through piston rod 40, through the open valve 54, into filter housing 64 and outwardly through filter 72. During the initial downward movement of piston rod 40, valve 34 will be closed.

Downward pressure on push handle 56 is then released so that spring 54 will cause piston rod 40 to return to its uppermost extended position. As spring 54 moves piston rod 40 upwardly, a suction is created in the interior of dip tube 20 so that ink in container 14 will be drawn into the elbow 38 and upwardly into dip tube 20 since valve 34 will be opened by the suction in dip tube 20. At that time, dip tube 20 will be filled with ink. Piston rod 40 is then depressed which will cause the ink in dip tube 20 to be forced upwardly through piston rod 40 since valve 34 will be closed. The ink passing upwardly through piston rod 40 will then be forced or pumped through the filter housing 64 and through the filter 72 to remove the impurities from the ink. As piston rod 40 is subsequently moved upwardly within dip tube 20, additional ink will be drawn into the dip tube 20. The process is repeated until the desired amount of ink has been filtered.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

We claim:

1. An ink pump and ink filtering system for pumping ink from a first container to a second container and for filtering the ink during the pumping operation, comprising:
an elongated, generally vertically disposed ink dip tube having open upper and lower ends and an inner wall surface;
said ink dip tube adapted to be extended downwardly into the ink in the first container;
said dip tube having a first valve seat provided thereon below its said lower end which has a lower ink intake side and an upper ink discharge side;
a first valve in said dip tube which is movably positioned at said upper ink discharge side of said first valve seat;
said first valve being movable between a first position wherein said first valve closes said upper ink discharge side of first valve seat to a second position wherein said first valve is unseated from said first valve seat to permit the ink in the first container to be drawn upwardly into said dip tube;
a compression spring in said dip tube which has upper and lower ends;
an elongated hollow piston rod having upper and lower ends;
said piston rod slidably extending downwardly into said upper end of said dip tube;
said piston rod being movable between an upper extended position and a lower retracted position with respect to said dip tube;
said piston rod having a hollow piston fixed thereto adjacent said lower end thereof which slidably sealably engages said inner wall surface of said dip tube as said piston rod is moved between its said first and second positions;
said compression spring yieldably urging said piston rod towards its said upper extended position;
a second valve seat in said piston rod adjacent said upper end thereof;
said second valve seat having a lower ink intake side and an upper ink discharge side;
a second valve movably positioned at said upper ink discharge side of said second valve seat;
said second valve being movable between open and closed positions;
a push handle secured to said upper end of said hollow piston rod;
said push handle having an ink passageway formed therein which has an ink inlet end and an ink discharge end;
said ink inlet end of said ink passageway in said push handle being in fluid communication with said upper ink discharge side of said second valve seat;
said second valve, when in its said open position, permitting ink to flow from said upper end of said piston rod to said ink inlet end of said ink passageway in said push handle when said piston rod is moved from its said extended position to its said retracted position;
said second valve being moved to its said closed position when said piston rod is moved from its said retracted position to its said extended position;
a generally vertically disposed filter housing having an upper ink intake end and a lower ink discharge end;
said upper ink end of said filter housing being in fluid communication with said ink discharge end of said ink passageway in said push handle;
an ink filter positioned in said filter housing at said lower ink discharge end thereof;
said filter housing being disposed laterally of said push handle, said piston rod and said dip tube so that said filter housing may be positioned over the second container;
said ink discharge end of said filter housing being disposed in a plane which is higher than said lower end of said dip tube.

2. The structure of claim 1 wherein said ink filter comprises a flexible screen means.

3. The structure of claim 1 wherein an elongated dip tube extender is secured to said lower end of said dip tube and extends downwardly therefrom.

4. The structure of claim 1 wherein a hollow elbow fitting is secured to said lower end of said dip tube which is adapted to rest upon the bottom of the first container.

5. The structure of claim 1 wherein said filter housing includes a selectively removable cap so that said ink filter may be removed from said filter housing for cleaning or replacement.

6. The structure of claim 1 wherein said filter is disc-shaped.

7. An ink pump and ink filtering system for pumping ink from a first container to a second container and for filtering the ink during the pumping operation, comprising:
an elongated, generally vertically disposed pump having an intake end and a discharge end;
said pump being at least partially positioned in the first container so that said intake end of said pump is in fluid communication with the ink in the first container;
a push handle operatively secured to said discharge end of said pump;
said push handle having an ink passageway formed therein which has an ink inlet end and an ink discharge end;
said ink inlet end of said ink passageway in said push handle being in fluid communication with said discharge end of said pump;
a generally vertically disposed filter housing having an upper ink intake end and a lower ink discharge end;
said upper ink end of said filter housing being in fluid communication with said ink discharge end of said push handle;
an ink filter positioned in said filter housing;
said filter housing being positioned laterally of said pump so that said filter housing may be positioned over the second container.

8. The structure of claim 7 wherein said filter housing is disposed in a plane which is higher than the ink intake end of said pump.

9. The structure of claim 8 wherein said pump is a manually operated pump.

10. The structure of claim 7 wherein said ink filter comprises a flexible screen means.

11. The structure of claim 7 wherein an elongated dip tube is secured to said ink inlet end of said pump.

12. The structure of claim 7. wherein said pump includes a dip tube which extends downwardly from said ink inlet end of said pump.

13. The structure of claim 12 wherein a hollow elbow fitting is secured to the lower end of said dip tube which is adapted to rest upon the bottom of the first container.

14. The structure of claim 7 wherein said filter housing includes a selectively removable cap so that said filter may be removed from said filter housing for cleaning or replacement.

15. The structure of claim 7 wherein said filter is disc-shaped.

16. The structure of claim 7 wherein said pump is an electrically driven pump.

17. A fluid pump and fluid filtering system for pumping fluid from a first container to a second container and filtering the fluid during the pumping operation, comprising:
an elongated, generally vertically disposed pump having an intake end and a discharge end;
said pump being at least partially positioned in the first container so that said intake end of said pump is in fluid communication with the fluid in the first container;
a push handle operatively secured to said discharge end of said pump;
said push handle having a fluid passageway formed therein which has a fluid inlet end and a fluid discharge end;
said fluid inlet end of said fluid passageway in said push handle being in fluid communication with said discharge end of said pump;
a generally vertically disposed filter housing having an upper fluid intake end and a lower fluid discharge end;
said upper fluid end of said filter housing being in fluid communication with said fluid discharge end of said push handle;
a fluid filter positioned in said filter housing;
said filter housing being laterally of said pump so that said filter housing may be positioned over the second container.
